(19) United States
(12) Patent Application Publication
(10) Pub. No.: US 2005/0056485 A1
(43) Pub. Date: Mar. 17, 2005

(54) Ladder accessory

(76) Inventor: Kenneth P. Tarlow, Corte Madera, CA (US)

Correspondence Address: Kenneth P. Tarlow, 21 Golden Hind PSG, Corte Madera, CA, 94925, US

(21) Appl. No.: 10/651,193

(22) Filed: Aug. 29, 2003

(51) Int. Cl. E06C 5/32

(52) U.S. Cl. 182/129

(57) ABSTRACT

Ladder Accessory with a first clamp assembly, a second clamp assembly, a support pole and an open topped container. The first and second clamp assemblies are pinned to each other. The first clamp assembly grips the rail of a standard ladder. The second clamp assembly grips a pole and the pole capable of being adjusted to insure that the pole is in a vertical position. The container bottom has a centrally located pole retaining receptacle. A preferred embodiment includes a first bolt and associated first threaded knob, the first bolt passing through apertures in the arms of the first clamping assembly so that the first threaded knob can act to tighten or loosen the claming arms around the support rail of a standard ladder.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of ladder accessories and more specifically to ladder accessory that clamps to a ladder to hold items that are frequently used during ladder related activities.

Ladders for use in reaching areas above normal hand reach, have been in existence for thousands of years. In recent times ladders are frequently used for such chores as painting a house, construction activity, light bulb replacement and the like. Modern ladders often include a shelf member that folds out near the top rung of the ladder. This shelf is meant for resting items that are being used for a particular activity. For example, a paint can, a portable drill, a power stapler or the like. Unfortunately, items placed on such a shelf may slip off if the ladder is moved accidentally.

The shelf is frequently in the wrong position for ideal access during a particular activity. For example, when installing light bulbs, the ideal location for a shelf or other holding member would be above the top most step of the ladder. There have been a number of attempts over the last eighty five years to address the issue of an accessory holding device for a ladder. These include U.S. Pat. No. 1,243,732 by Goss, U.S. Pat. No. 4,418,793 by Brent, U.S. Pat. No. 4,569,449 by Brent, U.S. Pat. No. 4,662,594 by Dubis and U.S. Pat. No. 5,544,718 by Schumacher. Although the above patents address the issue of an accessory for a ladder allowing a person to hold various items, none of the designs shown includes the ideal combination of features that are shown in the present patent application. For example, many of the prior art patents show the accessory held to a ladder by a traditional C clamp or some close variation thereof. My experiments have shown that it is more effective to hold the accessory device onto a ladder by means of a clamshell type clamp that includes a through bolt thereby causing the two sides of the clamshell to be drawn together rather than pushing on one side of a C member. This is particularly true when the clamping member is molded from an economic material such as rigid plastic. Additionally, the present invention incorporates a cam member the the interior of the clamp to help keep the clamp from rotating on the ladder rail that it is attached to. Another deficiency in the above listed patented inventions is that they describe the holding portion as a type of tray. My experiments have shown that the ideal configuration of the holder is a deeper open toped container having side walls that include one or more U shaped cutouts, thereby allowing the holder to effectively retain a gallon paint can as well as other odd shaped items that can be gotten to by placing one's hand through the U shaped openings. Another deficiency in the previous inventions is that there is no provision for the user to easily remove the holding portion of the invention without also removing the clamping portion. My invention allows one to easily remove and carry the holding portion away from the ladder at any time. Additionally, although some of the prior inventions allow for an angle adjustment so that the tray portion remains parallel to the ground, They only allow for adjustment in one plane, whereas there may be cause for adjustment in two planes if the ladder is situated on sloping ground. My invention accommodates an angle adjustment in two planes. Finally, the prior inventions tend to be complicated to manufacture and are rather cumbersome, making them less desirable to purchase and transport from one location to another. My invention is economical to manufacture, can be stored in a small space, and is easy to carry from one location to another.

For the above reasons as well as others that will be made evident, the present invention is novel and an advancement in the field of ladder accessories.

### BRIEF SUMMARY OF THE INVENTION

The primary object of the invention is to provide a ladder accessory that holds items that are frequently used when using a ladder.

Another object of the invention is to provide a ladder accessory that makes using ladders safer and easier.

Another object of the invention is to provide a ladder accessory that is easy to adjust and assemble.

A further object of the invention is to provide a ladder accessory that attaches to most types and sizes of ladders.

Yet another object of the invention is to provide a ladder accessory that clamps securely to a ladder.

Still yet another object of the invention is to provide a ladder accessory that can safely hold a standard gallon can of paint.

Another object of the invention is to provide a ladder accessory that can be adjusted to hold items in an upright position even though the clamping means is at an angle.

Another object of the invention is to provide a ladder accessory where the container portion can be removed and used independently of the clamping portion.

A further object of the invention is to provide a ladder accessory where the container portion can be raised or lowered according to the job being performed.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a ladder accessory comprising: a first clamp assembly, a second clamp assembly, a support pole, an open topped container, said first and second clamp assembly fixedly pinned to each other, said second clamp assembly including a pole clamping means, and said pole clamping means capable of being adjusted to insure that said pole is in a vertical position, said container bottom having a centrally located pole retaining receptacle, said first clamp assembly capable of gripping a standard ladder rail.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention attached to a ladder.

FIG. 2 is a perspective view of the clamping portion of the invention.

FIG. 3 is a perspective view of an alternate embodiment of the present invention.

FIG. 4 is a perspective view of the container portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

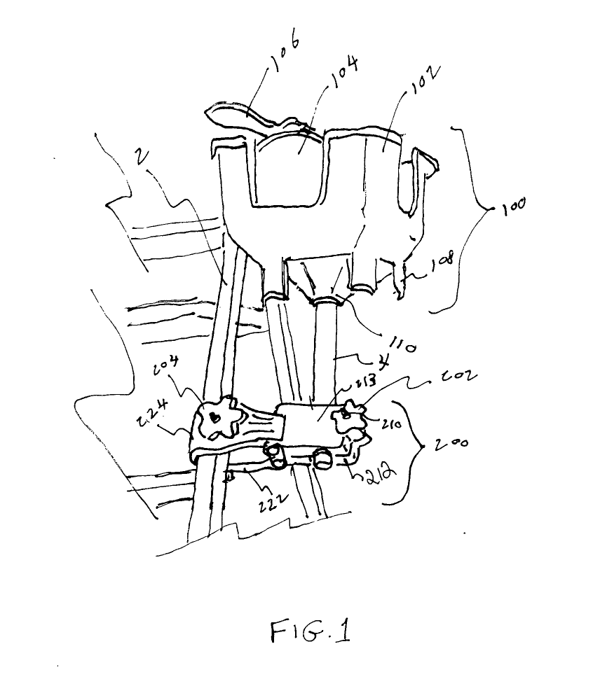

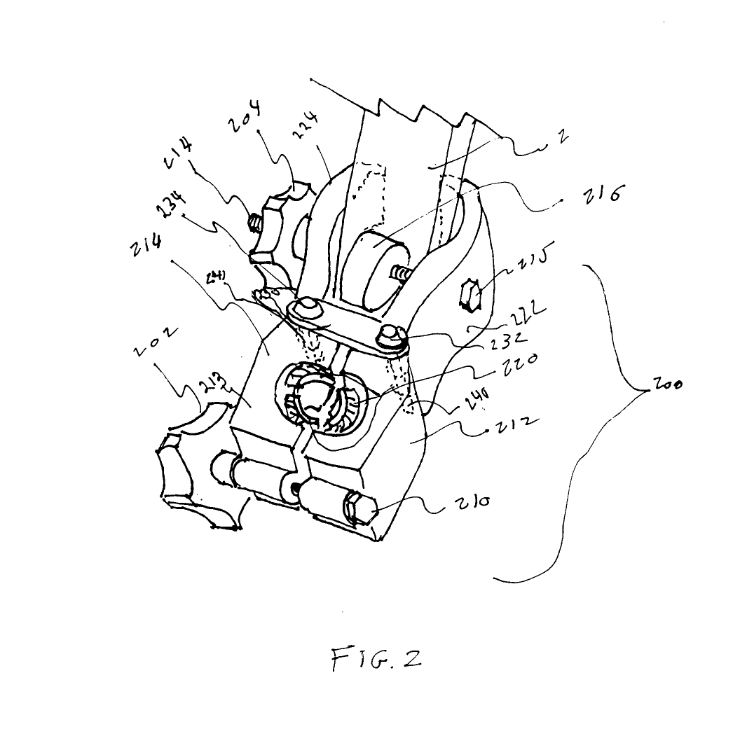

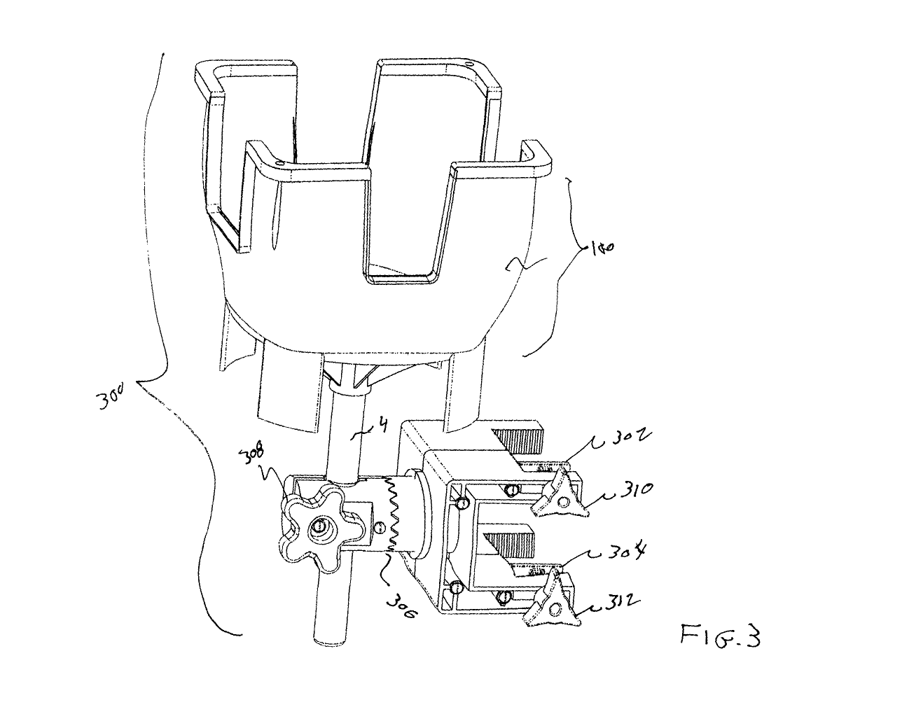

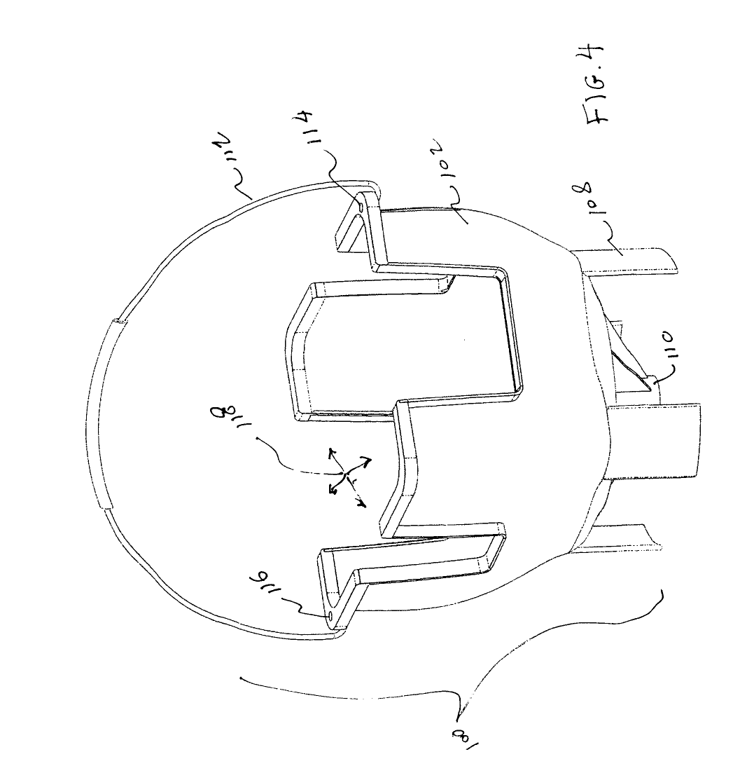

Referring now to FIG. 1 we see a perspective view of the present invention which includes a clamping assembly 200, a support pole 4 and a container assembly 100. The clamping assembly 200 is comprised of a first clamp 212, 213 that is capable of retaining the support pole 4, and a second clamp assembly 222, 224 that removably retains a ladder rail 2. The support pole 4 penetrates a female receptacle 110 to support container 100. The support pole 4 is removable and replaceable from receptacle 110 and is preferably made of one inch diameter metal conduit. Pole 4 is approximately ten inches long. This length is designed to fit diagonally inside the container 100 which makes it ideal for compact packing and storage. The container 100 is removable from support pole 4 so that the user can carry the container 100 away from the ladder without having to remove the clamping assembly 200. If the user wishes to install a longer support pole, he or she may do so by going to a local hardware store and purchasing a desired length of standard metal conduit. As shown in FIG. 4, the container 100 includes a plurality of integral legs 108 so that the container can be set on a level surface without tipping. Handle portion 112 is attached at apertures 114, 116 and allows a user to easily carry the container 100. The handle 112 can be swung away to one side when accessing the top opening of the container 100. Referring now to FIG. 2 we see a perspective view of the clamping assembly 200 attached to a ladder rail 2. The clamping assembly 200 is comprised of a first clamp 212, 213 and a second clamp 222, 224. Both clamps are attached by pins 240, 241 shown by dotted lines. The pins pass through aperture in tie plate 230 and a similar plate, not shown, on the bottom of the clamp assembly 200. Retaining nuts 232, 234 hold pins 240, 241 in place so that they form hinge pins for the two clamps. This configuration allows the clamping members 212, 213, 222, 224, to swing open and closed like a book. Knobs 202, 204 can then act to squeeze the clamping members shut when tightened against the support pole 4 and ladder rail 2. Three identical post clamping shim members 220 are retained in the space between the two clamping halves 212, 213. When the support pole 4 is inserted into the clamping members 220 and the user turns knob 202 so that bolt 210 is drawn inward, the claming shim members 220 grip the support pole and hold it in place. The combined outer configuration of the shim members 220 is spherical and the concavity formed by clamping members 212, 213 is spherical so that the user can rotate the support pole 4 approximatly twenty degrees in any axis before final tightening by knob 202. This allows the user to position the support pole 4 and attached open topped container 100 so that the container bottom is perfectly horizontal regardless of ladder rail angle or the slanted terrain that may support the ladder. The user can unscrew knob 202 slightly to raise or lower support pole 4 as needed. The second clamping members 222, 224 grip ladder rail 2. Through bolt 214, 215 terminates at one side in threaded tightening knob 204. When the knob is turned, it draws clamping arms 222, 224 together which is more efficient than a standard C clamp assembly and allows the clamping members to be made of less expensive materials such as air whipped polypropylene or the like. Cam member 216 can be positioned by the user to snug up against the side of ladder rail 2 thereby preventing the clamping arms 222, 224 from rotating which would cause the entire clamping assembly 200 to sag and render the entire invention less useful. FIG. 3 shows an alternate embodiment of the present invention 300. This embodiment employs a more conventional C clamp assembly where movable plates 302 304 fasten against a standard ladder rail when knobs 310 312 are turned. Serrated joint 306 allows pole 4 to be positioned in a vertical orientation so that container 100 can be horizontal. Knob 308 locks pole 4 into position. Because this embodiment uses conventional C clamp technology, the clamp would have to be constructed of extremely rigid material such as high strength steel or glass filled nylon.

The above description and illustrations show that the present invention is a novel and practical device that can easily attach to a variety of styles of ladders and safely hold a variety of useful items in close proximity to a person while working on a ladder. The holding container bottom can be positioned to be perfectly horizontal and can be adjusted up or down on its support pole. The entire device is inexpensive to manufacture and can be packed into a relatively small space for shipping and storage. The container portion is removable and replaceable so that the user can transport items in the container without having to carry the clamping mechanism.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. Ladder Accessory comprising:
a first clamp assembly;
a second clamp assembly;
a support pole;
an open topped container;
said first and second clamp assembly hingably pinned to each other;
said second clamp assembly including a pole clamping means; and
said pole clamping means capable of being adjusted to insure that said pole is in a vertical position;
said container bottom having a centrally located pole retaining receptacle;
said first clamp assembly capable of gripping a standard ladder rail.

2. Ladder Accessory as claimed in claim 1 further comprising a first bolt and associated first threaded knob;
said first bolt passing through apertures in the arms of said first clamping assembly so that said first threaded knob can act to tighten or loosen said claming arms around the support rail of a standard ladder.

3. Ladder Accessory as claimed in claim 1 further comprising a second bolt and associated second threaded knob;
said second bolt passing through apertures in the arms of said second clamping assembly so that said second threaded knob can act to tighten or loosen said clamping arms around said support pole.

4. Ladder Accessory as claimed in claim 1 wherein said container includes a plurality of supporting legs and a handle so that a user can easily hand carry items in said container and can set said container down in a stable way on a flat surface.

5. Ladder Accessory as claimed in claim 1 wherein said container includes U shaped cutouts in one or more sides thereby making it easier for a user to access items stored in said container.

6. Ladder Accessory as claimed in claim 1 further comprising a cam member; said cam member having a transverse aperture capable of receiving said first bolt in conjunction with said first clamp assembly so that said cam member can be rotated to touch said ladder rail thereby improving the holding power of said first clam assembly.

7. Ladder assembly as claimed in claim 1 further comprising a plurality of pole retaining shim members that fit within said second clamping assembly;
said combined shim members having a spherical outer shape that interacts with a concave hemispherical shapes located on the inside of each said clamping member of said second clamping assembly so that a user may adjust said support pole to approximately twenty degrees in any angle thereby helping to insure that said container bottom is horizontal.
